(19) United States
(12) Patent Application Publication
(10) Pub. No.: US 2013/0242571 A1
(43) Pub. Date: Sep. 19, 2013

(54) LED LAMP

(71) Applicants: BAO-MIN YANG, Foshan City (CN); GUANG YU, Foshan City (CN)

(72) Inventors: BAO-MIN YANG, Foshan City (CN); GUANG YU, Foshan City (CN)

(73) Assignees: FOXCONN TECHNOLOGY CO., LTD., Tu-Cheng (TW); CHAMP TECH OPTICAL (FOSHAN) CORPORATION, Foshan (CN)

(21) Appl. No.: 13/596,084

(22) Filed: Aug. 28, 2012

(30) Foreign Application Priority Data
Mar. 14, 2012 (CN) 201210066630.X

(51) Int. Cl. F21V 15/04

(52) U.S. Cl. 362/369

(57) ABSTRACT

An LED lamp includes a shell having an opening and defining a cavity, a light source received in the cavity of the shell, a fence arranged at the opening of the shell, and four locking members. Each locking member includes a securing portion and an elastic portion connected to the securing portion. The securing portions are fixed on the shell. The elastic portions cooperatively provide an elastic force to fix the fence to the shell. By bending the elastic portions of the locking members outwardly, the fence is released from its secure attachment to the shell.

### BACKGROUND

1. Technical Field

The present disclosure generally relates to lamps and, more particularly, to a light emitting diode (LED) lamp, wherein the LED lamp can be easily assembled and disassembled.

2. Description of Related Art

LEDs have many advantages, such as high luminosity, low operational voltage, low power consumption, compatibility with integrated circuits, easy driving, long term reliability, and environmental friendliness, which have promoted the wide use of LEDs as a light source.

Conventionally, an LED lamp includes a light source having a plurality of LEDs, and a frame covering the light source. The frame is fixed on the LED lamp with screws. However, it is necessary to dissemble the frame from the LED lamp when one or more of the LEDs is broken and needs to be replaced or maintained. Both the dissembling and assembling require rotating the screws by using a screwdriver. These operations are laborious and time-consuming. In addition, in the process of disassembling or assembling the LED lamp, the screwdriver needs to be carefully operated; the LED lamp may be damaged due to a careless operation of the screwdriver to the screws.

What is needed, therefore, is an LED lamp having a light source which can be easily assembled and disassembled.

### BRIEF DESCRIPTION OF THE DRAWINGS

FIG. 1 is an assembled view of an LED lamp, in accordance with an embodiment of the present disclosure.

FIG. 2 is an exploded view of the LED lamp of FIG. 1.

FIG. 3 is an enlarged cross-sectional view of the LED lamp of FIG. 1.

FIG. 4 is an enlarged view of a locking member of the LED lamp of FIG. 1.

FIG. 5 is an enlarged view of the locking member engaged with a shell of the LED lamp of FIG. 1.

FIG. 6 is an enlarged view of a circled portion VI of the LED lamp of FIG. 1.

### DETAILED DESCRIPTION

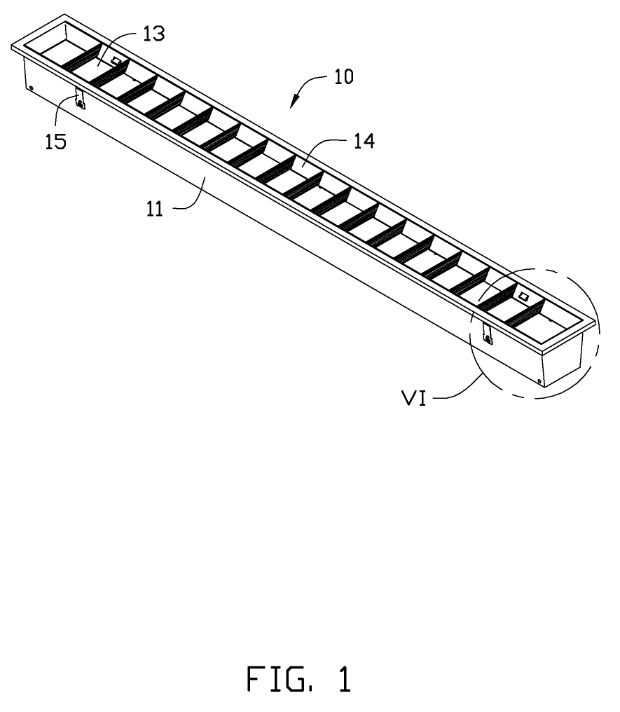

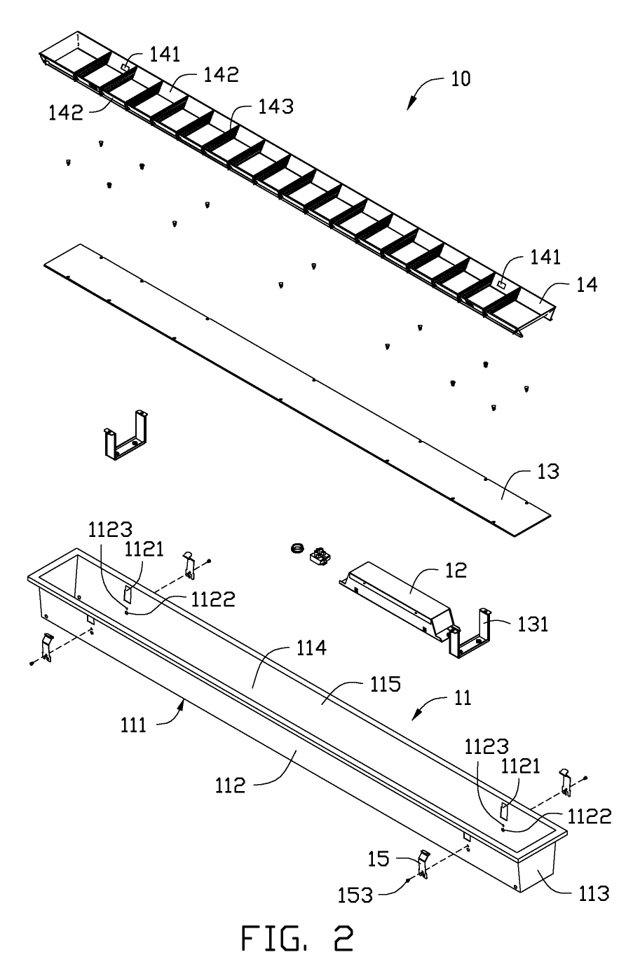

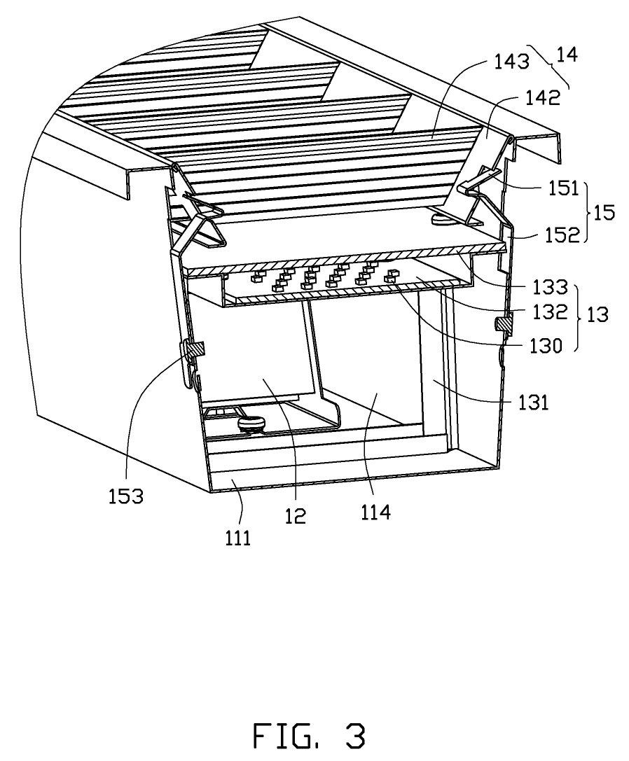

Referring to FIGS. 1 to 3, an exemplary embodiment of an LED lamp 10 includes a shell 11, a driver module 12 received in the shell 11, a light source 12 received in the shell 11, a fence 14 arranged on the light source 12, and a plurality of locking members 15 mounted on the shell 11.

The shell 11 includes a bottom plate 111, two first side plates 112 extending upwardly from two opposite sides of the bottom plate 111, and two second side plates 113 extending upwardly from two ends of the bottom plate 111. The bottom plate 111, the first side plates 112 and the second side plate 113 cooperatively define a cavity 114 thereamong. An opening 115 is defined in a top of the cavity 114 opposite to the bottom plate 111. The LED lamp 10 is fixed on a supporting member such as a ceiling via the bottom plate 111. Each first side plate 112 defines a plurality of clasp holes 1121, a plurality of locating holes 1122, and a plurality of latch holes 1123. Each one of the clasp holes 1121, a corresponding one of the locating holes 1122 and a corresponding one of the latch holes 1123 are used to match with a corresponding locking member 15. The clasp hole 1121 and the corresponding locating and latch holes 1122, 1123 are arranged in a line perpendicular to the bottom plate 111, wherein the latch hole 1123 is located between the clasp hole 1121 and the locating hole 1122. In other words, each locating hole 1122 is located below a corresponding clasp hole 1121, and each latch hole 1123 is located between a corresponding clasp hole 1121 and a corresponding locating hole 1122. The positions of the clasp holes 1121, the locating holes 1122 and the latch holes 1123 at one of the first side plates 112 are the same as those at the other first side plate 112.

The driver module 12 is mounted on the bottom plate 111 and received in the cavity 114. The driver module 12 is provided for supplying power to the light source 13, whereby the light source 13 can obtain the required electrical power for generating light.

The light source 13 is received in the cavity 114 of the shell 11. The light source 13 is mounted on the bottom plate 111 via a holder 131. In the present embodiment, the light source 13 includes a base 132, and a plurality of LEDs 130 arranged on the base 132, and a lens 133 spaced from the LEDs 130 and located at the light output path of the LEDs 130. The holder 131 has a U-shaped configuration with a horizontal bottom portion and two vertical legs extending from two ends of the bottom portion. The bottom portion of the holder 131 is mounted on the bottom plate 111 of the shell, and the base 132 is arranged on the legs of the holder 131; therefore, the base 132 is spaced from the bottom plate 111.

A shape of the fence 14 is such configured that the fence 14 is fittingly received in the opening 115. The fence 14 is fixed on the shell 11 via the locking members 15. The fence 14 can protect the light source 13 and the driver module 12. The fence 14 includes two side walls 142 inclined toward each other along a direction toward the base 132 of the light source 13, and a plurality of spaced partitions 143 connected to and arranged between the two side walls 142. The side walls 142 extend along a longitudinal direction of the base 132 of the light source 13. The partitions 143 are parallel to each other, and each partition 143 is perpendicular with the side walls 142. In other words, the partitions 143 extend along a transverse direction of the base 132 of the light source 13. Inner surface (not labeled) of the side walls 142 and the outer surface (not labeled) of the partitions 143 can reflect light emitted from the LEDs 130. Each side wall 142 defines a plurality of fixing holes 141, and each fixing hole 141 corresponds to one of the clasp holes 1121 of the first side plates 112 of the shell 11.

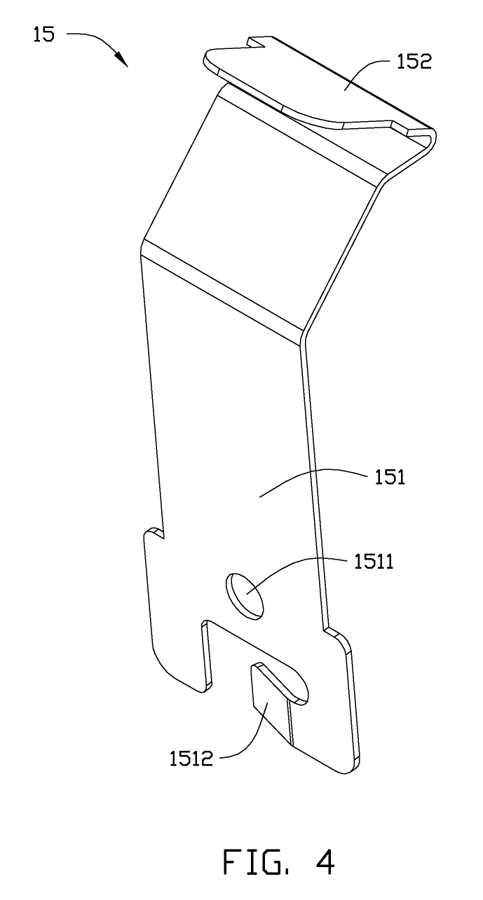

Referring to FIG. 4 also, the locking member 15 includes a securing portion 151 and a free elastic portion 152. The elastic portion 152 includes a first portion extending from an end of the securing portion 151 and towards an inside of the shell 11, and a second portion extending from the first portion of the elastic portion 152 and towards an outside of the shell 11; therefore, the elastic portion 152 has a substantially V-shaped configuration with an opening facing towards the outside of the shell 11. The securing portion 151 defines a through hole 1511 at the other end away from the elastic portion 152. The through hole 1511 corresponds to the latch hole 1123 of the shell 11. An arced limiting protrusion 1512 is formed on the other end of the securing portion 151 away from the elastic portion 152. The limiting protrusion 1512 locates at a position corresponding to a corresponding locating hole 1122 of the shell 11, extends horizontally and is bent inwardly.

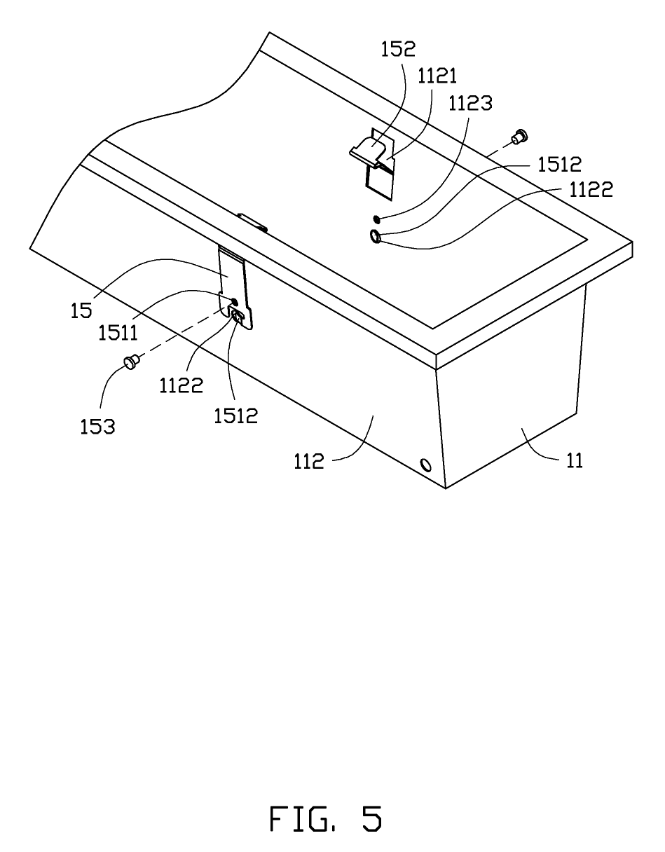

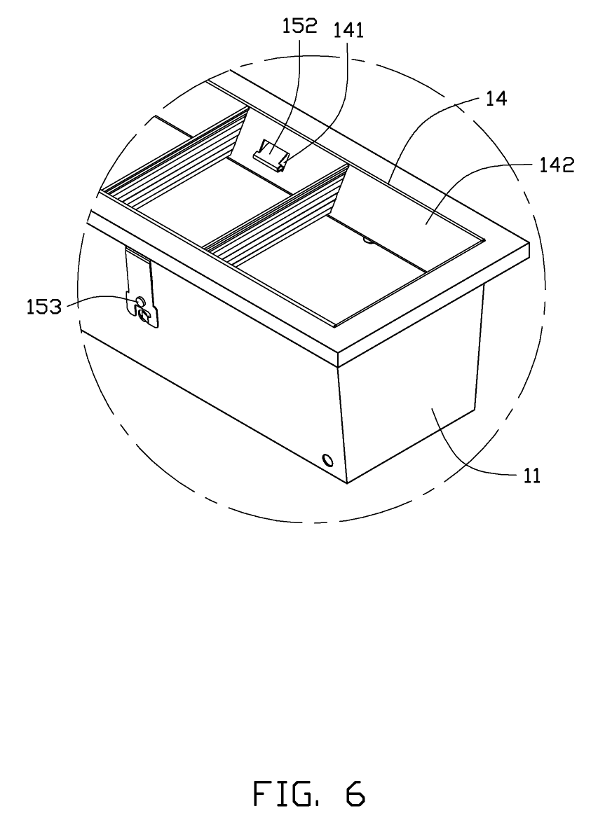

Referring to FIGS. 5 and 6 also, in assembly of the LED lamp 10, each screw 153 is extended through a corresponding through hole 1511 of the locking member 15 and a corresponding latch hole 1123 of the shell 11 to fix the securing portion 151 on an outer surface of the first side plate 112 of the shell 11. The limiting protrusion 1512 is engagingly received in the locating hole 1122 of the shell 11; therefore, the locking member 15 cannot rotate relative to the shell 11 about the corresponding screw 153. The elastic portion 152 inserts into a corresponding clasp hole 1121 of the first side plate 112 and extends through the first side plate 112 to locate in the cavity 114 of the shell 11. The fence 14 is located at the opening 115 of the shell 11 and pressed downwardly whereby the side walls 142 of the fence 14 abut the elastic portions 152 to make the elastic portions 152 deform. When the fence 14 reaches a predetermined position, the elastic portions 152 resume and each latch is in a corresponding fixing hole 141 of the fence 14; therefore, the fence 14 is fixed on the shell 11 via the clasp of the elastic members 15. Light emitted from the LEDs 130 travels through the lens 133 and then radiates through the fence 14 to an outside for lighting.

When the fence 14 needs to be detached from the shell 11, the elastic portion 152 of the locking member 15 is pressed and elastically deformed towards the outside of the shell 11 to cause the elastic portion 152 to disengage from the fixing hole 141; therefore, the fence 14 is able to be pulled up from the shell 11.

By utilizing the locking member 15, the fence 14 can be easily assembled and detached from the shell 11.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp, comprising:
a shell having an opening and defining a cavity;
a light source received in the cavity of the shell;
a fence arranged at the opening of the shell; and
two locking members, each locking member comprising a securing portion and an elastic portion connected to the securing portion, the securing portion being fixed on the shell, the elastic portion providing an elastic force to fix the fence on the shell.

2. The LED lamp of claim 1, wherein the shell defines two clasp holes at two opposite first side plates, the fence defining two fixing holes corresponding to the clasp holes, the securing portion of the each locking member being fixed on a corresponding first side plate of the shell, the elastic portion extending through a corresponding clasp hole of the shell and latching in a corresponding fixing hole of the fence to fix the fence to the shell.

3. The LED lamp of claim 2, wherein the elastic portion has a V-shaped configuration with an opening facing towards an outside of the shell.

4. The LED lamp of claim 1, wherein the shell comprises a bottom plate, two first side plates extending from two opposite sides of the bottom plates, and two second side plates extending from two ends of the bottom plates, the bottom plate, the first side plates and the second side plates cooperatively defining the cavity thereamong.

5. The LED lamp of claim 4, wherein each first side plate defines a latch hole, the securing portion of the each locking member defining a through hole corresponding to the latch hole, a screw being extended through the through hole and a corresponding latch hole to fix each locking member on the shell.

6. The LED lamp of claim 4, wherein each first side plate defines a locating hole, each locking member further comprising an arc limiting protrusion away from the elastic portion, the limiting protrusion engagingly received in a corresponding locating hole to fix each locking member on the shell.

7. The LED lamp of claim 1, wherein the fence comprises two inclined side walls toward each other, and a plurality of spaced partitions arranged between the two side walls.

8. The LED lamp of claim 7, wherein the partitions are parallel to each other, and perpendicular to the side walls.

9. An LED lamp, comprising:
a shell comprising two opposite first side plates, the shell having an opening and defining a cavity, each first side plate defining a plurality of clasp holes therein;
a light source received in the cavity of the shell;
a fence arranged at the opening of the shell, the fence comprising two inclined side walls toward each other, each side wall defining a plurality of fixing holes therein, and the fixing holes corresponding to the clasp holes, respectively; and
a plurality of locking members, each locking member comprising a securing portion and an elastic portion connected to the securing portion, the securing portion being fixed on the shell, each elastic portion extending through a corresponding clasp hole of the shell and latching in a corresponding fixing hole of the fence to fix the fence on the shell.

10. The LED lamp of claim 9, wherein the elastic portion has a V-shaped configuration with an opening facing towards an outside of the shell.

11. The LED lamp of claim 9, wherein each first side plate defines a plurality locating holes, the each locking member further comprising an arc limiting protrusion away from the elastic portion, the limiting protrusion being engagingly received in a corresponding locating hole to fix each locking member on the shell.

12. The LED lamp of claim 9, wherein the shell further comprises a bottom plate and two second side plates, the two first side plates extending from two opposite sides of the bottom plate, the two second side plates extending from two ends of the bottom plate, the bottom plate, the first side plates and the second side plates cooperatively defining the cavity.

13. The LED lamp of claim 9, wherein the fence further comprises a plurality of partitions connected to and arranged between the two side walls.

14. The LED lamp of claim 13, wherein the partitions are parallel to each other, and perpendicular to the side walls.
